(19) United States
(12) Patent Application Publication
(10) Pub. No.: US 2021/0354376 A1
(43) Pub. Date: Nov. 18, 2021

(54) METHOD FOR PRODUCING AN ADDITIVELY MANUFACTURED AND TREATED OBJECT

(71) Applicant: Covestro Intellectual Property GmbH & Co. KG, Leverkusen (DE)

(72) Inventors: Dirk Achten, Leverkusen (DE); Frank-Stefan Stern, Bergisch Gladbach (DE); Christoph Tomczyk, Leverkusen (DE); Roland Wagner, Leverkusen (DE); Bettina Mettmann, Pulheim (DE); Thomas Buesgen, Leverkusen (DE); Nicolas Degiorgio, Krefeld (DE); Jonas Kuenzel, Leverkusen (DE); Maximilian Wolf, Köln (DE)

(21) Appl. No.: 17/286,512

(22) PCT Filed: Nov. 7, 2019
(86) PCT No.: PCT/EP2019/080582

§ 371 Date: Apr. 19, 2021

(30) Foreign Application Priority Data
Nov. 13, 2018 (EP) 18205986.5

(51) Int. Cl. B29C 64/165; B29C 64/188; B29C 64/35; B29C 64/371; B29C 64/268; B33Y 10/00; B33Y 40/20; B33Y 70/00

(52) U.S. Cl. CPC B29C 64/165; B29C 64/188; B29C 64/35; B33Y 70/00; B29C 64/268; B33Y 10/00; B33Y 40/20; B29C 64/371

(57) ABSTRACT

The invention relates to a method for producing a treated object, comprising the steps: a) producing an object by means of additive manufacturing, the object being produced by the repeated arrangement, layer by layer, of at least one first material on a substrate spatially selectively in accordance with a cross-section of the object, the method comprising the additional method step: b) at least partially bringing the object, which is still on the substrate or has already been detached from the substrate and which has been produced by additive manufacturing, into contact with a liquid heated to ≥T or a powder bed of a second material heated to ≥T for a time ≥1 minute in order to obtain the treated object, T standing for a temperature of ≥25° C. The invention further relates to an object produced by a method of this type.

The present invention relates to a method of creating an article by means of additive manufacturing. The present invention further relates to an article created by such a method.

Additive manufacturing methods refer to those methods by which articles are built up layer by layer. They therefore differ markedly from other methods of producing articles such as milling or drilling. In the latter methods, an article is processed such that it takes on its final geometry via removal of material. Thus, an additive method is a material-adding method, whereas conventional methods can be referred to as material-removing methods.

On the basis of the materials, for instance the polymers, that are nowadays used predominantly in powder-based additive manufacturing methods, articles that are formed have mechanical properties that can differ fundamentally from the characteristics of the materials as known in other plastics processing methods, such as injection molding. When processed by the additive manufacturing methods, the thermoplastic materials used lose their specific characteristics.

Nylon-12 (PA12) is the material currently most commonly used for powder-based additive manufacturing methods, for example laser sintering. PA12 is notable for high strength and toughness when it is processed by injection molding or by extrusion. A commercial PA12, for example, after injection molding has an elongation at break of more than 200%. PA12 articles that are produced by the laser sintering method, by contrast, show elongations at break around 15%. The component is brittle and therefore can no longer be regarded as a typical PA12 component. The same is true of polypropylene (PP), which is supplied in powder form for laser sintering. This material too becomes brittle and hence loses the tough, elastic properties that are typical of PP. The reasons for this are to be found in the morphology of the polymers.

During the melting operation by means of laser or IR and especially in the course of cooling, an irregular inner structure of the so-called semicrystalline polymers arises (for example PA12 and PP). The inner structure (morphology) of semicrystalline polymers is partly characterized by a high level of order. A certain proportion of the polymer chains forms crystalline, tightly packed structures in the course of cooling. During melting and cooling, these crystallites grow irregularly at the boundaries of the incompletely molten particles and at the former grain boundaries of the powder particles and on additives present in the powder. The irregularity of the morphology thus formed promotes the formation of cracks under mechanical stress. The residual porosity which is unavoidable in the powder-based additive method promotes the growth of cracks.

Brittle properties of the components thus formed are the result. For elucidation of these effects, reference is made to European Polymer Journal 48 (2012), pages 1611-1621. The elastic polymers based on block copolymers that are used in laser sintering also show a profile of properties untypical of the polymers used when they are processed as powder by additive manufacturing methods to give articles. Thermoplastic elastomers (TPE) are nowadays used in laser sintering. Articles that are produced from the TPEs now available have high residual porosity after solidification, and the original strength of the TPE material is not measurable in the article manufactured therefrom. In practice, these porous components are therefore subsequently infiltrated with liquid, hardening polymers in order to establish the profile of properties required. In spite of the additional measure mentioned, strength and elongation remain at a low level. The additional method complexity—as well as the still-inadequate mechanical properties—leads to poor economic viability of these materials.

In laser sintering methods using polymer particles, these are generally processed in a closed volume or chamber in order that the particles can be processed in a heated atmosphere. In this way it is possible to reduce the temperature differential that has to be overcome for sintering of the particles by action of the laser. In general, it can be stated that the thermal properties of the polymer affect the possible processing temperatures in laser sintering methods. Therefore, the prior art has proposed various solutions for such polymers and methods of processing them.

US 2005/0080191 A1 relates to a powder system for use in solid freeform fabrication methods, comprising at least one polymer having reactive properties and meltable properties, wherein the at least one polymer is selected in order to react with a liquid binder and is meltable at a temperature above the melting point or glass transition temperature of the at least one polymer. The at least one polymer may comprise at least one reactive polymer and at least one meltable polymer, and the at least one meltable polymer may have a melting point or glass transition temperature in the range from about 50° C. to about 250° C.

There is still a need in the prior art for additive manufacturing methods in which the components obtained have homogeneous material properties.

It is therefore an object of the present invention to at least partly overcome the disadvantages known from the prior art. More particularly, it is an object of the present invention to provide a way in which high stability in particular of the components manufactured, especially also parallel to a layer direction, and/or homogeneous component properties can be enabled.

The object is achieved in accordance with the invention by a method having the features of claim 1.

The object is further achieved in accordance with the invention by an article having the features of 16. Preferred configurations of the invention are described in the dependent claims, in the description or the FIGURES, and further features described or detailed in the dependent claims or in the description or the FIGURES, individually or in any combination, may be a subject of the invention, unless the context clearly indicates otherwise.

The present invention provides a process for producing a treated article, comprising the steps of:

a) creating the article by means of additive manufacturing, wherein
the article is created by arranging at least one first material on a substrate repeatedly in layers and in a spatially selective manner corresponding to a cross section of the article. What is envisaged here is that the method has the further method step of:
b) at least partly contacting the article created by additive manufacturing which is still present on the substrate or has already been detached from the substrate with a liquid heated to ≥T or a powder bed of a second material heated to ≥T for a period of ≥1 min, preferably for a period of ≥1 min to ≤2 h, in order to obtain the treated article,
wherein

T is a temperature of ≥25° C., preferably of ≥50° C., more preferably of ≥75° C., especially preferably of ≥150° C.

Such a method permits, in a particularly advantageous manner, the creating of an article by means of additive manufacture,

wherein
the article created has high stability and at the same time has homogeneous properties.

The present invention thus relates to a method of creating an article by means of additive manufacturing. The article to be produced here is not fundamentally limited. More particularly, additive manufacture permits, in an effective manner, creation of a wide variety of different articles for a wide variety of different uses, and at the same time to permit unlimited geometries. Accordingly, the article to be manufactured is also not subject to any restriction; instead, the method described here can in principle serve to shape any article that can be created by an additive method. However, the method described here is particularly preferred for those articles that require high stability or homogeneous mechanical properties.

With regard to the additive method, this is also likewise not restricted. In principle, this method may be possible for any additive method.

Additive manufacturing methods refer to those methods by which articles are built up layer by layer. They therefore differ markedly from other methods of producing articles such as milling or drilling. In the latter methods, an article is processed such that it takes on its final geometry via removal of material.

Additive manufacturing methods use different materials and processing techniques to build up articles layer by layer. In fused deposition modeling (FDM), for example, a thermoplastic wire is liquefied and deposited layer by layer on a movable build platform using a nozzle. Solidification gives rise to a solid article. The nozzle and build platform are controlled on the basis of a CAD drawing of the article. If the geometry of this article is complex, for example with geometric undercuts, support materials additionally have to be printed and removed again after completion of the article.

In addition, there exist additive manufacturing methods that use thermoplastic powders to build up articles layer by layer. In this case, thin layers of powder are applied by means of what is called a coater and then selectively melted by means of an energy source. The surrounding powder here supports the component geometry. Complex geometries can thus be manufactured more economically than in the above-described FDM method. Moreover, different articles can be arranged or manufactured in a tightly packed manner in what is called the powder bed. Owing to these advantages, powder-based additive manufacturing methods are among the most economically viable additive manufacturing methods on the market. They are therefore used predominantly by industrial users. Examples of powder-based additive manufacturing methods are what are called selective laser sintering (SLS) or high-speed sintering (HSS). They differ from one another in the method of introducing into the plastic the energy for the selective melting. In the laser sintering method, the energy is introduced via a deflected laser beam. In what is called the high-speed sintering (HSS) method, as described, for example, in EP 1648686, the energy is introduced via infrared (IR) sources in combination with an IR absorber selectively printed into the powder bed. What is called selective heat sintering (SHS) utilizes the printing unit of a conventional thermal printer in order to selectively melt thermoplastic powders.

Direct powder method/powder bed systems are known as laser melting methods and are commercially available under various trade names, such as selective laser melting (SLM), lasercusing and direct metal-laser sintering (DMLS). The sole exception from this process principle is the electron beam melting (EBM) process, in which an electron beam is used under full vacuum. Welding devices for metallic powder beds are nowadays available from Concept Laser GmbH, EOS GmbH, ReaLizer GmbH, Renishaw and SLM Solutions GmbH in Europe. These companies offer a multitude of systems based on the similar principle of selective laser melting, but give different names to their own processes. 3D Systems, based in the USA, also offers systems based on selective laser melting. The choice of correct machine depends on the requirements of the end user, some of the main features of the system in question being the type of laser unit, the handling of the powder and the build chamber.

Arcam AB, based in Sweden, manufactures powder bed welding systems that use an electron beam as energy source for the melting process. A hybrid system that combines powder bed welding with CNC machining is supplied by the Japanese company Matsuura.

Another system that uses a powder bed is the Höganäs digital metal method. This system was developed by fcubic and uses a precision inkjet in order to deposit a special “ink” on a 45 micrometer-thick layer of metal powder. A further 45 micrometer powder layer is applied and the printing step is repeated until the component is complete. The part is then discharged and sintered in order to achieve the ultimate size and strength. One of the advantages of this system is that the build takes place at room temperature (RT, corresponding to 20° C.) without partial melting that occurs with laser or electron beam methodology. In principle, there is also no need for any support structures during the build since these are supported by the powder bed.

Even though systems with powder supply use the same starting material, there is a considerable difference in the manner in which the material is added layer by layer. The powder flows through a nozzle, and is melted directly on the surface of the treated part by a jet.

Systems with powder supply are referred to as laser cladding, directed energy deposition and laser metal deposition. The method is highly precise and is based on automated deposition of a material layer having a thickness between 0.1 mm and several centimeters. The metallurgical bonding of the sheath material to the base material and the absence of undercuts are some of the features of this method. The process differs from other welding techniques in that a small heat input penetrates through the substrate.

A development of this technology is the laser engineered net shaping (LENS) powder supply system, which is used by Optomec. This method permits the adding of material to an existing part, which means that it can be used to repair expensive metal components that have been damaged, such as sheared turbine blades and injection-molding inserts, and offers high flexibility in the clamping of the parts and the “coating” materials.

Companies that supply systems working by the same principle are: BeAM from France, Trumpf from Germany and Sciaky from the USA. An interesting approach to a hybrid system is the approach supplied by DMG Mori. The combination of the laser cladding principle with a 5-axis machining system opens up new fields of use in many branches of industry.

The ADAM (atomic diffusion additive manufacturing) process from Markforged begins with the choice of various metal powders. The next step is to shape the powder layer by layer in plastic binder. After the printing, the part is sintered in an oven that burns off the binder and consolidates the powder in an ultimate metal part of full density.

In summary, by way of example, additive methods employable in the context of this method are those described above and include, for instance, the additive methods enumerated hereinafter. Suitable examples include high-speed sintering, selective laser melting, selective laser sintering, selective heat sintering, binder jetting, electron beam melting, fused deposition modeling, fused filament fabrication, build-up welding, friction stir welding, wax deposition modeling, contour crafting, metal powder application methods, cold gas spraying, stereolithography, 3D screen printing methods, light-scattered electrophoretic deposition, printing of highly metal powder-filled thermoplastics by the FDM method, nanoscale metal powder by an inkjet method, DLP (direct light processing), ink-jetting, continuous light interface processing (CLIP).

The method described here first of all comprises, in method step a), the creating of an article by means of additive manufacture, wherein the article is created by arranging, especially applying and/or melting and/or polymerizing and/or bonding, at least one first material on a substrate repeatedly in layers and in a spatially selective manner corresponding to a cross section of the article. This step is thus a customary operation for additive methods.

The substrate used may in principle be any surface on which the article can be built. For example, but without limitation, the substrate may be a solid substrate. The material from which the article is to be formed is built here in accordance with the cross section of the article to be created in multiple successive layers. The cross section of the article is thus the cross section of every layer, such that the article is built overall in accordance with the cross-sectional profile and hence in accordance with its geometry.

In additive manufacturing methods or in 3D printing methods that work by the two-dimensional method, just like in stereolithography methods, a photopolymer solution is exposed. The exposure here is not effected at specific points by means of a laser beam, but over a two-dimensional area. For this purpose, an exposure matrix is projected onto the respective layer in order to cure the material at these sites.

In the DLP (digital light processing) method, a dot pattern is projected onto the photopolymer surface from above and the build platform drops into the solution layer by layer. The advantage of this method is that different exposure intensity also allows variation of the curing. This makes it easier to remove support constructions, for example, if they have cured to a lesser degree.

In the 3D printing method referred to as LCM (lithography-based ceramic manufacturing), the photopolymer bath is exposed not from the top but from the bottom. Specifically, this method is employed to expose a mixture of solid constituents (ceramic) and a photopolymer solution. The resultant green body is sintered after the 3D printing and the binder is burnt out. The advantage of this 3D printing method is the option of using different granules.

CLIP (continuous liquid interface production) methodology can be used to produce objects without visible layers. The photopolymerization of the liquid resin is controlled by means of matching of UV light (curing) and oxygen (prevents curing). The base of the resin tank consists of a transparent and permeable material, like that of contact lenses. This allows a “dead zone” to be created by means of oxygen in the lowermost layer, which enables the further building of the object which is drawn continuously upward out of the tank.

In stereolithography (the SLA method), a light-curing plastic which is also referred to as photopolymer is cured in thin layers by a laser. The method takes place in a melt bath filled with the base monomers of the light-sensitive (photosensitive) plastic. After each step, the workpiece is lowered into the bath by a few millimeters and returned to a position below the previous position by the magnitude of one layer thickness.

Especially when the first material is a metal, the additive method used may be a method that works by means of inkjet technology. An example that may be mentioned here is binder jetting.

In addition, the first material used may in principle be any material that can be processed by means of an additive method. Thus, the material used may, for example, be any material that can be melted under suitable conditions and solidifies again. Moreover, it is possible to use only a first material, or it is possible to use a material mixture, or it is possible to use multiple first materials. If multiple first materials are used, these may be arranged in different layers or else in the same layers.

In principle, the first material may be in powder form on the substrate or else may be applied in already molten form to the substrate.

In an advantageous embodiment of the method of the invention, at least a portion of the first material includes a meltable polymer. Preferably, the entire first material, or all the particles used as first material in the method, include(s) a meltable polymer. It is further preferable that at least 90% by weight of the particles has a particle diameter of ≤0.25 mm, preferably ≤0.2 mm, more preferably ≤0.15 mm. The particles comprising the meltable polymer may have, for example, a homogeneous construction such that no further meltable polymers are present in the particles.

Suitable powders of thermoplastic materials can be produced via various standard processes, for example grinding processes, cryogenic grinding, precipitation processes, spray-drying processes and others.

As well as the meltable polymer, the particles may also comprise further additives such as fillers, stabilizers and the like, but also further polymers. The total content of additives in the particles may, for example, be ≥0.1% by weight to ≤60% by weight, preferably ≥1% by weight to ≤40% by weight.

In a further preferred embodiment, the meltable polymer is selected from: polyetheretherketone (PEEK), polyaryletherketone (PAEK), polyetherketoneketone (PEKK), polyethersulfones, polyimide, polyetherimide, polyesters, polyamides, polycarbonates, polyurethanes, polyvinylchloride, polyoxymethylene, polyvinylacetate, polyacrylates, polymethacrylates, TPE (thermoplastic elastomers), thermoplastics such as polyethylene, polypropylene, polylactide, ABS (acrylonitrile-butadiene-styrene copolymers), PETG (a glycol-modified polyethylene terephthalate), or else polystyrene, polyethylene, polypropylene and blends and/or alloys of the polymers mentioned.

The meltable polymer is preferably a polyurethane obtainable at least partly from the reaction of aromatic and/or aliphatic polyisocyanates with suitable (poly)alcohols and/or (poly)amines or blends thereof. Preferably, at least a proportion of the (poly)alcohols used comprises those from the group consisting of: linear polyesterpolyols, polyetherpolyols, polycarbonatepolyols, polyacrylatepolyols or a combination of at least two of these. In a preferred embodiment, these (poly)alcohols or (poly)amines bear terminal alcohol and/or amine functionalities. In a further preferred embodiment, the (poly)alcohols and/or (poly)amines have a molecular weight of 52 to 10 000 g/mol. Preferably, these (poly)alcohols or (poly)amines as feedstocks have a melting point in the range from 5 to 150° C. Preferred polyisocyanates that can be used at least in part for preparation of the meltable polyurethanes are TDI, MDI, HDI, PDI, H12MDI, IPDI, TODI, XDI, NDI and decane diisocyanate. Particularly preferred polyisocyanates are HDI, PDI, H12MDI, MDI and TDI.

It is likewise preferable that the meltable polymer is a polycarbonate based on bisphenol A and/or bisphenol TMC.

It may alternatively be the case that the first material is a metal. In this configuration, fields of use may lie, for instance, in medical technology, in the aviation sector, in the automotive sector or in the jewellery manufacturing sector. Suitable metals for the first material include, for example, tool steels, maraging steels or martensite-hardening steels, stainless steel, aluminum or aluminum alloys, cobalt-chromium alloys, nickel-based alloys, for instance superalloys, titanium and titanium alloys, for instance in commercial purity, copper and copper alloys, or precious metals, for instance gold, platinum, palladium, silver. In the method of the invention, an article is built layer by layer. If the number of repetitions for application and irradiation is sufficiently small, it is also possible to make reference to a two-dimensional article which is to be built. Such a two-dimensional article can also be characterized as a coating. For example, ≥2 to ≤20 repetitions for application and irradiation can be conducted for the build thereof.

A method of producing an article from a precursor, which may likewise be part of the method described here and especially of step a), comprises the steps of:

I) depositing a free-radically crosslinked resin on a carrier, which can also be referred to as substrate, to obtain a ply of a construction material joined to the carrier which corresponds to a first selected cross section of the precursor;
II) depositing a free-radically crosslinked resin atop a previously applied ply of the construction material to obtain a further ply of the construction material which corresponds to a further selected cross section of the precursor and which is joined to the previously applied ply;
III) repeating step II) until the precursor has formed; wherein the depositing of a free-radically crosslinked resin at least in step II) is effected by exposure and/or irradiation of a selected region of a free-radically crosslinkable resin corresponding to the respectively selected cross section of the precursor.

In the method, after step III), step IV) is further conducted:

IV) treating the precursor obtained after step III) under conditions sufficient to obtain postcrosslinking in the free-radically crosslinked resin by the action of further actinic radiation and/or thermally induced post-curing.

In this configuration, the article is thus obtained in two production phases. The first production phase can be regarded as the build phase. This build phase can be implemented by means of ray optics-based additive manufacturing methods such as the inkjet method, stereolithography or the DLP (digital light processing) method and is represented by steps I), II) and III). The second production phase can be regarded as the curing phase and is the subject of step IV). The precursor or intermediate object obtained after the build phase is converted here to a more mechanically durable object without any further change in the shape thereof. In the context of the present invention, the material from which the precursor is obtained in the additive manufacturing process is referred to generally as “build material”.

Step I) of the process comprises depositing a free-radically crosslinked resin on a carrier. This is usually the first step in inkjet, stereolithography and DLP processes. In this way, a ply of a build material joined to the carrier that corresponds to a first selected cross section of the precursor is obtained.

As per the instructions for step III), step II) is repeated until the desired precursor is formed. Step II) comprises depositing a free-radically crosslinked resin onto a previously applied ply of the build material to obtain a further ply of the build material that corresponds to a further selected cross section of the precursor and which is joined to the previously applied ply. The previously applied ply of the build material may be the first ply from step I) or a ply from a previous iteration of step II).

According to the invention, a free-radically crosslinked resin—at least in step II) (and preferably in step I too)—is deposited through exposure and/or irradiation of a selected region of a free-radically crosslinkable resin corresponding to the cross section of the article selected in each instance. This may be effected either by selective exposure (stereolithography, DLP) of the resin or by selective application of the resin followed by an exposure step which, on account of the preceding selective application of the resin, no longer needs to be selective (inkjet process).

In the context of the present invention, the terms “free-radically crosslinkable resin” and “free-radically crosslinked resin” are used. The free-radically crosslinkable resin is converted here into the free-radically crosslinked resin by exposure and/or irradiation, which triggers free-radical crosslinking reactions. What is meant here by “exposure” is the action of light in the range between near-IR and near-UV light (wavelength 1400 nm to 315 nm). The remaining shorter wavelength ranges are covered by the term “irradiation”, for example far-UV light, x-radiation, gamma radiation and also electron beams.

The respective cross section is appropriately selected by a CAD program with which a model of the article to be produced has been created. This operation is also known as “slicing” and serves as a basis for controlling the exposure and/or irradiation of the free-radically crosslinkable resin.

The free-radically crosslinkable resin preferably has a viscosity (23° C., DIN EN ISO 2884-1:2006-09) of ≥5 mPas to ≤100 000 mPas. It should thus be regarded as a liquid resin at least for the purposes of additive manufacturing. The viscosity is preferably ≥50 mPas to ≤10 000 mPas, more preferably ≥500 mPas to ≤1000 mPas.

As well as the curable components, the free-radically crosslinkable resin preferably includes a non-curable component, such as stabilizers, fillers and the like.

The treating in step IV) may in the simplest case be storage at room temperature RT (20° C.), or preferably at a temperature above room temperature RT.

It is preferable that step IV) is performed only when the entirety of the build material of the precursor has reached its gel point. The gel point is considered to have been reached when, in a dynamic-mechanical analysis (DMA) with a plate/plate oscillation viscometer in accordance with ISO 6721-10:2015 at 20° C., the graphs of the storage modulus G′ and of the loss modulus G″ intersect. The precursor is optionally subjected to further exposure and/or irradiation to bring free-radical crosslinking to completion. The free-radically crosslinked resin can exhibit a storage modulus G′ (DMA, plate/plate oscillation viscometer according to ISO 6721-10:2015 at 20° C. and a shear rate of l/s) of ≥10⁶ Pa.

The free-radically crosslinkable resin may further contain additives such as fillers, UV-stabilizers, free-radical inhibitors, antioxidants, mold release agents, water scavengers, slip additives, defoamers, flow agents, rheology additives, flame retardants and/or pigments. These auxiliaries and additives, excluding fillers and flame retardants, are typically present in an amount of less than 10% by weight, preferably less than 5% by weight, more preferably up to 3% by weight, based on the free-radically crosslinkable resin. Flame retardants are typically present in amounts of not more than 70% by weight, preferably not more than 50% by weight, more preferably not more than 30% by weight, calculated as the total amount of employed flame retardants based on the total weight of the free-radically crosslinkable resin.

Examples of suitable fillers are AlOH₃, CaCO₃, metal pigments such as TiO₂ and other known customary fillers. These fillers are preferably used in amounts of not more than 70% by weight, preferably not more than 50% by weight, particularly preferably not more than 30% by weight, calculated as the total amount of fillers used, based on the total weight of the free-radically crosslinkable resin.

Suitable UV stabilizers may preferably be selected from the group consisting of piperidine derivatives such as 4-benzoyloxy-2,2,6,6-tetramethylpiperidine, 4-benzoyloxy-1,2,2,6,6-pentamethylpiperidine, bis(2,2,6,6-tetramethyl-4-piperidyl) sebacate, bis(1,2,2,6,6-pentamethyl-1-4-piperidinyl) sebacate, bis(2,2,6,6-tetramethyl-4-piperidyl) suberate, bis(2,2,6,6-tetramethyl-4-piperidyl) dodecanedioate; benzophenone derivatives such as 2,4-dihydroxybenzophenone, 2-hydroxy-4-methoxybenzophenone, 2-hydroxy-4-octoxybenzophenone, 2-hydroxy-4-dodecyloxybenzophenone or 2,2′-dihydroxy-4-dodecyloxybenzophenone; benzotriazole derivatives such as 2-(2H-benzotriazol-2-yl)-4,6-di-tert-pentylphenol, 2-(2H-benzotriazol-2-yl)-6-dodecyl-4-methylphenol, 2-(2H-benzotriazol-2-yl)-4,6-bis(1-methyl-1-phenylethyl)phenol, 2-(5-chloro-2H-benzotriazol-2-yl)-6-(1,1-dimethylethyl)-4-methylphenol, 2-(2H-benzotriazol-2-yl)-4-(1,1,3,3-tetramethylbutyl)phenol, 2-(2H-benzotriazol-2-yl)-6-(1-methyl-1-phenylethyl)-4-(1,1,3,3-tetramethylbutyl)phenol, isooctyl 3-(3-(2H-benzotriazol-2-yl)-5-(1,1-dimethylethyl)-4-hydroxyphenylpropionate), 2-(2H-benzotriazol-2-yl)-4,6-bis(1,1-dimethylethyl)phenol, 2-(2H-benzotriazol-2-yl)-4,6-bis(1-methyl-1-phenylethyl)phenol, 2-(5-chloro-2H-benzotriazol-2-yl)-4,6-bis(1,1-dimethylethyl)phenol; oxalanilides such as 2-ethyl-2′-ethoxyoxalanilide or 4-methyl-4′-methoxyoxalanilide; salicylic esters such as phenyl salicylate, 4-tert-butylphenyl salicylate, 4-tert-octylphenyl salicylate; cinnamic ester derivatives such as methyl α-cyano-β-methyl-4-methoxycinnamate, butyl α-cyano-β-methyl-4-methoxycinnamate, ethyl α-cyano-β-phenylcinnamate, isooctyl α-cyano-β-phenylcinnamate; and malonic ester derivatives, such as dimethyl 4-methoxybenzylidenemalonate, diethyl 4-methoxybenzylidenemalonate, dimethyl 4-butoxybenzylidenemalonate. These preferred light stabilizers can be used either individually or in any desired combinations with one another.

Particularly preferred UV stabilizers are those that completely absorb radiation of a wavelength <400 nm. These include, for example, the benzotriazole derivatives mentioned. Especially preferred UV stabilizers are 2-(5-chloro-2H-benzotriazol-2-yl)-6-(1,1-dimethylethyl)-4-methylphenol, 2-(2H-benzotriazol-2-yl)-4-(1,1,3,3-tetramethylbutyl)phenol and/or 2-(5-chloro-2H-benzotriazol-2-yl)-4,6-bis(1,1-dimethylethyl)phenol.

One or more of the UV stabilizers recited by way of example are optionally added to the free-radically crosslinkable resin preferably in amounts of 0.001 to 3.0% by weight, more preferably 0.005 to 2% by weight, calculated as the total amount of employed UV stabilizers based on the total weight of the free-radically crosslinkable resin.

Suitable antioxidants are preferably sterically hindered phenols, which may be selected preferably from the group consisting of 2,6-di-tert-butyl-4-methylphenol (ionol), pentaerythritol tetrakis(3-(3,5-di-tert-butyl-4-hydroxyphenyl)propionate), octadecyl 3-(3,5-di-tert-butyl-4-hydroxyphenyl)propionate, triethylene glycol bis(3-tert-butyl-4-hydroxy-5-methylphenyl)propionate, 2,2′-thiobis(4-methyl-6-tert-butylphenol), and 2,2′-thiodiethyl bis[3-(3,5-di-tert-butyl-4-hydroxyphenyl)propionate]. These may be used either individually or in any desired combinations with one another as required. These antioxidants are preferably used in amounts of 0.01 to 3.0% by weight, more preferably 0.02 to 2.0% by weight, calculated as the total amount of antioxidants used based on the total weight of the free-radically crosslinkable resin.

Suitable free-radical inhibitors/retarders are in particular those that specifically inhibit uncontrolled free-radical polymerization of the resin formulation outside the desired (irradiated) region. These are key for good contour sharpness and imaging accuracy in the precursor. Suitable free-radical inhibitors must be chosen according to the desired free-radical yield from the irradiation/exposure step and the polymerization rate and reactivity/selectivity of the double bond-bearing compounds. Examples of suitable free-radical inhibitors are 2,2-(2,5-thiophenediyl)bis(5-tert-butylbenzoxazole), phenothiazine, hydroquinones, hydroquinone ethers, quinone alkyds and nitroxyl compounds and mixtures thereof, benzoquinones, copper salts, catechols, cresols, nitrobenzene, and oxygen. These antioxidants are preferably used in amounts of 0.001% by weight to 3% by weight.

In addition to and especially after the above-described method step a) and hence after the building of the article or after the building of the geometry of the article, it is further envisaged that the method described here has the following further method step:

b) at least partly contacting the article created by additive manufacturing which is still present on the substrate or has already been detached from the substrate with a liquid heated to ≥T or a powder bed of a second material heated to ≥T for a period of ≥1 min in order to obtain the treated article, wherein
T is a temperature of ≥25° C., preferably of ≥50° C., more preferably of ≥75° C., especially preferably of ≥150° C., and wherein
the temperature is preferably chosen such that, where appropriate, for instance in the case of a polymer as first material, the glass transition temperature Tg of the first material is attained, and wherein
the second material is especially different than the first material.

In this method step, the article shaped beforehand is thus treated further in order thus to obtain the desired article. More particularly, this method step b) serves to improve the properties of the article created, especially with regard to its stability and the homogeneity of its properties, and the retention of the desired geometric shape of the article shaped beforehand.

For this purpose, there is at least partial, and hence only partial or else complete, contacting of the article created by additive manufacturing that is still present on the substrate or has already been detached from the substrate. Thus, the article can, for instance, be detached from the substrate and, for instance, be placed into the liquid or the powder bed in order thus to enable the contacting. It is also possible that the substrate is provided in a space which can be filled with powder for formation of the powder bed or a liquid in order thus to enable contacting of the article with the liquid or the powder bed. However, this step is not limited to the aforementioned examples.

The contacting is especially to be effected under defined conditions. More particularly, the contacting is to be effected at elevated pressure and hence at a pressure above the atmospheric pressure of 1 bar. Alternatively, the contacting can also be implemented at a reduced pressure, i.e. at a pressure below the atmospheric pressure of 1 bar. In principle, however, contacting at standard pressure, i.e. at 1 bar, is also encompassed by the scope of the present invention.

Moreover, it is especially envisaged that the contacting is effected using a powder bed or a liquid which, before or during the contacting and hence the contact of the article and the powder bed or the liquid, is heated to a temperature T within a region of ≥25° C., preferably of ≥50° C., more preferably of ≥75° C., especially preferably of ≥150° C. For example, the temperature T to which the powder bed or the liquid is heated may be within a region of ≥45° C., for example of ≥60° C., further preferably of ≥90° C., further preferably of ≥120° C., further preferably of ≥150° C., further preferably of ≥180° C.

It is further envisaged in a selected embodiment that the contacting is effected with a transparent liquid having sufficient UV-VIS transparency and UV-VIS stability in order to optionally regioselectively postcrosslink the preshaped article preferably at temperatures above the build space temperature of the upstream build process by means of radiation.

Furthermore, it is envisaged that the contacting is effected for a defined period of time. This period of time is especially within a region of ≥1 minute, for example of ≥5 minutes, further preferably of ≥5 minutes, further preferably of ≥10 minutes, further preferably of ≥15 minutes, further preferably of ≥20 minutes, but preferably <72 h, preferably <48 h and more preferably <24 h. It is preferably the case that the contacting is effected for a period of time within a range from 1 minute to 72 h, or preferably from 10 minutes to 48 h, or preferably from 20 minutes to 24 h.

In a preferred embodiment, the additively manufactured article is contacted with the powder bed or the liquid, where the liquid or the powder bed has a temperature of <50° C. and is subsequently heated up to the desired final temperature together with the additively manufactured article.

In a further preferred embodiment, the additively manufactured article, after the desired contact time, is cooled down to a temperature of <50° C. together with the heated liquid or the heated powder bed in a controlled manner before it is removed and freed of the liquid or the powder bed.

In this way, it is possible to specifically control postcrosslinking, sintering, crystallization or melting processes in order to alter the properties of the additively manufactured component in a desired manner.

In another preferred embodiment, the additively manufactured article is contacted with the already preheated powder bed or the liquid, the liquid or the powder bed being at a temperature of >50° C., and optionally already being at the target temperature.

In a further preferred embodiment, the additively manufactured article, after the desired contact time, is quenched together with the heated liquid or the heated powder bed to a temperature of <50° C., preferably <30° C., within a period of <10 min, preferably <5 min. Preferably, the article is quenched after the desired contact time with the heated liquid or the heated powder bed for a period within a range from 1 second to 10 min. The quenching is preferably performed by introducing into a fluid having a temperature below 50° C., preferably at a temperature within a range from 10 to 50° C. The fluid may be any fluid that the person skilled in the art would select for the purpose and meets the demands mentioned elsewhere. The fluid is preferably water, preferably at room temperature (20° C.).

In this way, it is possible to specifically control crystallization and melting processes, and also glass transition processes in particular, in order to alter the properties of the additively sintered component in a desired manner.

Desired properties here may be crystallite size, density, level of crystallization, hardness, strength, tensile strain, abrasion resistance, transparency and others.

Furthermore, the material of the powder bed or of the liquid and hence of the second material is also choosable and not fundamentally limited. Suitable powders are especially those which do not break down under the conditions chosen and which also do not react with the first material(s). In principle, it may be preferable that the powder of the powder bed is inert with respect to the first material(s).

The same also applies to the liquid. This too is choosable in principle, provided that it is inert with respect to the first material(s) and hence with respect to the materials from which the article is built. Furthermore, it is important in the case of use of liquids that the liquid is not a solvent for a first material.

In a preferred embodiment, it is also possible to use powders that are reversibly liquefied, or liquids that solidify, after heating in contact with the additively manufactured article. Examples include salts that melt at the desired sintering temperature or concentrated salt solutions that solidify on contact with the additively manufactured article at the desired temperature through evaporation of solvents, for example, or precipitation in solvents for example. In this way, the article can be ensheathed in the process with a stable shell that can subsequently be washed off, preferably by means of solvents such as water or alcohol.

In a further preferred embodiment, the additively manufactured article can be repeatedly dipped into a salt solution or other concentrated solutions of a low molecular weight material having a high melting point or glass transition point and subsequently dried until a stable crust forms. The crust preferably stabilizes the shape of the additively manufactured article for the later thermal treatment and can be readily washed off again with water or another solvent after said treatment. The solvent or water preferably does not swell the additively manufactured article in the treatment, or swells it only by ≤10% by volume, preferably ≤5% by volume, more preferably ≤3% by volume.

In a preferred embodiment, the 3D-manufactured article to be heat-treated can be dipped here into a salt solution and removed from it again, the salt on the surface can be dried, optionally thermally, the operation can optionally be repeated multiple times and hence a stable salt crust can be created, in which the article can be heated at the desired temperature, and the salt crust can be removed again from the article after the heat treatment by mechanical means or by means of suitable solvents, for example water, alkalis, acids.

In a further preferred embodiment, the additively manufactured article can be repeatedly dipped into a concentrated solution of a low molecular weight material having a high melting point or glass transition point and subsequently dried until a stable crust forms. The crust stabilizes the shape of the additively manufactured article for the later thermal treatment and can be readily washed off again by means of water or another solvent after said treatment.

It is a particular advantage of each of the methods described where a crust is formed around the article that porous structures can also be stabilized or obtained in a controlled manner by infiltration and stabilization of the pores in the product in the downstream thermal stress.

What is meant by “not a solvent” is more particularly that the solubility of the component in question in the liquid at 20° C. is ≤10 g/L, preferably ≤1 g/L, more preferably ≤0.1 g/L and especially preferably ≤0.01 g/L. Particularly suitable liquids also do not lead to any unwanted discoloration of the article and cause the article to swell only reversibly or preferably not at all.

With regard to the liquids, it is a particular feature of particularly suitable examples that they can be heated repeatedly to the softening temperature of the first material, for instance the thermoplastic, without showing degradation phenomena.

The surface tension of the liquid as the second material is preferably at least 10 mN/m less or greater than the surface tension of the first material, for instance the thermoplastic material of the component.

It is possible with preference to use apolar liquids of low volatility that can be heated to the desired temperatures under pressure, but are easily removable thereafter from the treated article obtained.

In principle, it may preferably be the case that the first material(s) is/are different than the material of the powder bed and of the liquid, or fundamentally than the second material. The second material may include any material that the person skilled in the art would use therefor for the purpose of the invention. The second material preferably has a higher melting point than the first material.

In a further preferred embodiment, the liquid used in method step b), as the second material, is selected from the group consisting of silicone oils, paraffin oils, fluorinated hydrocarbons, polyethylene waxes, saltwater, metal melts, salt melts or ionic liquids and mixtures of the aforementioned liquids. In the case of saltwater, preference is given to a saturated alkali metal or alkaline earth metal chloride solution, for example LiCl, KCl, NaCl and/or MgCl₂, CaCl₂) and mixtures thereof. It has been found that the aforementioned materials or liquids in particular are advantageous since these are stable and non-discoloring even under the conditions employed, for instance temperature and pressure, i.e. do not discolor the article in an oxidizing or reducing manner and have only low acidic or basic potential in water and, moreover, enable effective treatment of the article.

Advantageously, the powder bed used in method step b) contains particles as the second material selected from the group consisting of silicon dioxide, for instance sand or glass, polytetrafluoroethylene, aluminum oxide, metals, metal salts, sugars, organic salts, polyethylene wax, polyester, polyacrylic acid, polyethylene oxide, polyoxymethylene, polycarbonate or a mixture comprising at least one of the aforementioned substances. Particular preference is given here to powders having a high thermal conductivity of ≥0.2 Wm⁻¹K⁻¹. Thermal conductivity can be determined here as described in the publication TK04 Application Note, 2015, TeKa, Berlin, Germany “Testing fragments and powder”. Or powders that are solid at 23° C. and can be converted readily and reversibly between a solid and a melt at application temperature. Particularly advantageous products are therefore those that have a low viscosity <10 000 mPas, preferably <5000 mPas, more preferably <2000 mPas and even more preferably <1000 mPas in the melt at a temperature of 20° C. above the softening temperature and high brittleness in powder form, i.e. low deformability in solid form at 23° C., preferably elongation at break of <50%, preferably <30% and more preferably <20% in the tensile test to DIN EN ISO 527-2:2012. It has been found that the aforementioned materials in particular are advantageous since these are also stable under the conditions employed, for instance temperature and pressure, and also enable effective treatment of the article. Furthermore, the aforementioned materials can be removed from the article essentially without residue.

If the second material is used in the form of a powder bed, the powder particles of the second material preferably have a particle size within a range from 5 to 5000 μm, or preferably within a range from 10 to 2000 μm, or preferably within a range from 50 to 500 μm. The particle size is determined by laser diffraction by means of static laser diffraction analysis to ISO 13320:2009-10.

It is more preferable when the second material or the powder bed includes a metal salt. For the second material, it is especially possible to choose a salt that has a melting point higher than the melting point of the first material. This enables treatment of the article at high temperatures as well, advantageously with reduced risks to the user in handling and in contact with such salts at relatively high temperatures, since these can easily and rapidly be removed from the skin or clothing. Furthermore, it may be preferable when the salt is water-soluble since it is possible in this case to easily rinse the salt or second material off after the treatment or after method step b). It may particularly preferably be the case that the metal salt is selected from the group consisting of sodium chloride (NaCl), potassium chloride (KCl), magnesium chloride (MgCl₂), calcium chloride (CaCl₂), potassium carbonate (K₂CO₃), lithium chloride (LiCl), magnesium oxide (MgO), magnesium sulfate (MgSO₄), calcium oxide (CaO), calcium carbonate (CaCO₃) and magnesium fluoride (MgF₂).

The use of such metal salts can enable an improved surface structure of the article and achievement of a further improvement in stability. The improved surface structure is manifested, for example, in reduced porosity of the surface. The improved properties are manifested, for example, in an elevated hardness of the article, an elevated modulus of the article, an elevated tear strength of the article, with respect to the untreated article.

Furthermore, in the case of the above-described second materials, i.e. the above-described powders or liquids, or else in the case of other substances that are suitable as second materials, it may be advantageous that these are water-soluble. This is because water-soluble substances in particular can be partly dissolved in a simple manner on the article and hence removed therefrom.

It may further be preferable that the second material is soluble in an acid, a base or an organic solvent. In this configuration too, it is possible to partly dissolve substances in a simple manner on the article and hence remove therefrom.

It may further be the case that method step b) is effected using critical carbon dioxide as the second material. Critical carbon dioxide or supercritical CO₂ is formed when pressure and temperature are above the critical point for carbon dioxide: Thus, carbon dioxide should especially be present at a temperature of more than 304.13 K (30.980° C.) and at a pressure of more than 7.375 MPa (73.75 bar). A particular advantage of this configuration may be considered to be that the carbon dioxide can effectively treat the article under supercritical conditions and, after the treatment, can be removed from the article as gas under standard conditions in a particularly simple and residue-free manner.

In the method of the invention, the article obtained by the additive manufacturing method is thus contacted at least partly with a heated liquid or a heated powder bed. The article obtained remains dimensionally stable by virtue of the binder, and the at least one first material can be “sintered” or post-cured to give the treated article.

It has been found that especially the contacting of the article with the powder bed or with the liquid, as described elsewhere, can distinctly improve the properties of the article and also the method itself.

The method described here has multiple advantages over the selective laser sintering or/and high-speed sintering method which is common practice in the art or standard. For instance, the build space temperature may be low as in a method analogous to binder jetting. The subsequent but spatially separable sintering operation makes it possible for processes to be distinctly simplified and less costly, since no heated build spaces are needed.

The method of the invention also allows the processing of almost any thermoplastic powders since the problems with the build space method in the SLS and HS process do not occur. By the method of the invention, for the first time as far as the inventor is aware, it is also possible to process noncrystalline thermoplastics in a reliable method, i.e. with a build space temperature of preferably <5° C., more preferably <20° C. and most preferably <40° C., of the softening temperature of the powder used, preferably based on organic polymeric materials, to give high-quality mechanical components, i.e. components having at least 50% of the strength of injection-molded components.

The inventive method can further achieve complex component geometries since the liquid/the powder bed, analogously to the powder in the SLS and HS method, counteract gravity in a protective manner.

More particularly, it has been found that the article can attain improved stability even in a direction parallel to the plane of the layers created for building of the article. Furthermore, it is possible to obtain high homogeneity of the mechanical properties. Also by virtue of the fact that the inventive method can be performed under pressure. The pressure can preferably be attained here via a mechanical compression of the powder or liquid phase. In a preferred embodiment, the pressure can also be obtained by applying a positive pressure of a gas, for example.

In a further preferred embodiment, the gas used here is an inert gas that has neither oxidizing nor reducing action at the preferred treatment temperature. Preferred inert gases here are CO₂, N₂, argon, neon.

The method of the invention can give materials having higher density, hardness and strength than are obtained by standard sintering methods since the binder prevents some of the porosity that arises in a normal sintering method.

After the sintering, the temperature of the liquid or powder is preferably lowered to a value of <50° C. below the softening temperature of the article to be treated, and the treated article is obtained. The treated article is preferably washed.

After obtaining the article or after method step b), the article can be removed from the powder bed or the liquid and also optionally detached from the substrate. Subsequently, the article can be freed of residues of the powder bed or of the liquid.

In the case of provision of a powder bed, the article can be freed, for instance, of powder residues by means of standard methods such as brushing or compressed air. In the case of use of liquids, these can be washed off, for instance, by means of further solvents that are inert with respect to the article and/or the article can be dried.

It may preferably be the case that the method includes at least one further method step or a combination of further method steps selected from:
A) detaching the article created by additive manufacturing from the substrate before method step b);
B) at least partly removing unreacted first material, especially liquid material, powder or support material, from the additively manufactured article before method step b);
C) post-curing the article created by additive manufacturing in method step a) by means of actinic radiation;
D) cooling the heated liquid or the heated powder bed to a temperature in a region of <200° C., especially in a region of ≤160° C., preferably in a region of ≤130° C., further preferably in a region of ≤50° C., further preferably in a region of ≤30° C., before removal of the treated article after method step b);
E) at least partly removing the second material from the article by mechanical means during or after method step b), for example removing it by means of filtering, blowing, sucking, shaking, spinning or a combination of at least two of these; and
F) washing off the second material after method step b) after removal of the article from the liquid or the powder with a solvent, where the solvent is not a solvent or co-reactant for the first material at a temperature in a region of T ≤200° C., especially in a region of ≤150° C., preferably in a region of ≤100° C., further preferably in a region of ≤60° C., further preferably in a region of ≤40° C., further preferably in a region of ≤20° C., for a period of preferably ≤30 min, especially a period of ≤25 min, preferably a period of ≤20 min, further preferably a period of ≤15 min, further preferably a period of ≤10 min, further preferably a period of ≤5 min. The period is preferably ≥1 second to ≤30 min, or preferably ≥10 seconds to ≤20 min.

In the removal by washing, the second material is preferably removed in the first wash step to an extent of more than 90%, or preferably to an extent of more than 95%, or preferably to an extent of more than 99%, based on the total area of the article.

The above-described steps A) to F) thus describe further advantageous steps that can each be executed alone or in a combination that can fundamentally be freely chosen when the article has been sufficiently treated with the powder bed or with the liquid in method step b).

By method step A), it is possible to treat the article with the powder bed or the liquid in a particularly simple manner, and also to obtain particularly homogeneous properties.

Method step B) can enable direct action of the powder bed or the liquid on the article without any disruptive substances present on the article being able to lead to inhomogeneities.

Method step C) further allows the article to attain particularly high stability with simultaneously homogeneous properties.

Method step D) also allows procedurally advantageous removal of the article from the powder bed or from the liquid.

Method step E) also makes it possible to obtain the article in a high purity. This method step may be effected both for residues of the powder bed and of the liquid. The same in principle applies correspondingly to method step F).

After the article has been obtained, i.e. especially before method step b), its dimensional stability can also be increased by means of standard aftertreatment methods such as coating or infusion with suitable coating or infusion materials, for example an aqueous polyurethane dispersion, with subsequent drying and curing at temperatures of 20° C. or more below the softening temperature—the softening temperature being defined as the melting temperature of the untreated article—before it comes into contact with the inert liquid or the inert powder material.

In a further preferred embodiment, during the contacting of the article with the liquid or powder bed in method step b), the liquid or the powder bed is put under elevated pressure at least intermittently. Preferably, the relative pressure, i.e. the gauge pressure, is within a range from ≥1 bar to ≤1000 bar, especially ≥1.5 bar to ≤200 bar, preferably ≥2 bar to ≤50 bar, more preferably ≥2.5 bar to ≤20 bar and most preferably ≥4 bar to ≤10 bar. This pressurization can be conducted in suitable autoclaves made of glass or metal by means of injection of a suitable gas or by mechanical reduction of the autoclave volume. In the application of elevated pressure to the liquid or the powder bed, the temperature of the liquid or the powder bed may be lowered, for example by ≥5° C. or ≥10° C., compared to process variants without pressurization.

It may further be preferable that, during the contacting of the article with the liquid or powder bed in method step b), the liquid or the powder bed is put under elevated pressure or under reduced pressure at least intermittently. Preferably, the relative pressure, i.e. the reduced pressure, is within a range from ≥0.01 bar to ≤1 bar, especially ≥0.03 bar to ≤0.9 bar, preferably ≥0.05 bar to ≤0.8 bar, more preferably ≥0.08 bar to ≤0.7 bar. This evacuation can be conducted in suitable autoclaves made of glass or metal by means of removal of the suitable gas present in the autoclave or by mechanically increasing the autoclave volume. In the application of reduced pressure to the liquid or the powder bed, the temperature of the liquid or the powder bed may be lowered, for example by ≥5° C. or ≥10° C., compared to process variants without pressurization.

It may further be preferable that, during the contacting of the article with the second material in the form of the liquid or the powder bed in method step b), the powder bed or the liquid is at least intermittently flooded with an inert gas, or an inert gas is at least intermittently guided into liquid. An inert gas here may especially be understood to mean such a gas that does not react with the material of the article and with the material of the powder bed or of the liquid. More particularly, the gas should be configured such that it does not have any oxidizing properties with respect to the material(s) of the article and of the powder bed or of the liquid. Inert gas may more preferably be selected from the group consisting of helium (He), argon (Ar), nitrogen (N₂) and carbon dioxide (CO₂).

It may further be preferable that the temperature T established in method step b), expressed in degrees Celsius, averages ≤95% of the breakdown temperature of the first material, where the breakdown temperature is determined as the loss of 10% by weight in a TGA analysis under nitrogen at a heating rate of 20° C./minute of the first material. This allows effective treatment of the article to be combined with a treatment that is gentle on the article.

It may further be preferable that the temperature T in method step b) is within a range from ≥40° C. to ≤2000° C. It may be especially preferable here for the temperature T to be within a range from ≥50° C. to ≤1500° C., further preferably within a range from ≥60° C. to ≤1000° C., further preferably within a range from ≥80° C. to ≤800° C., further preferably within a range from ≥100° C. to ≤600° C., further preferably within a range from ≥140° C. to ≤300° C.

It is further preferable that the temperature T in method step b) is greater than a temperature 50° C. below the Vicat softening temperature (VST) of the first material, and that the temperature T is less than a temperature 150° C. above the Vicat softening temperature of the first material, where the Vicat softening temperature can be ascertained to DIN EN ISO 306:2014-03. It may be particularly preferable for the temperature T in method step b) to be greater than a temperature 30° C. below the Vicat softening temperature (VST) of the first material, and for the temperature T to be less than a temperature 120° C. above the Vicat softening temperature of the first material, further preferable for the temperature T in method step b) to be greater than a temperature 25° C. below the Vicat softening temperature (VST) of the first material, and for the temperature T to be less than a temperature 100° C. above the Vicat softening temperature of the first material, further preferable for the temperature T in method step b) to be greater than a temperature 20° C. below the Vicat softening temperature (VST) of the first material, and for the temperature T to be less than a temperature 90° C. above the Vicat softening temperature of the first material, further preferable for the temperature T in method step b) to be greater than a temperature 15° C. below the Vicat softening temperature (VST) of the first material, and for the temperature T to be less than a temperature 80° C. above the Vicat softening temperature of the first material. This allows effective treatment of the article to be combined with a treatment that is gentle on the article.

In a further preferred embodiment, the temperature T in method step b) is further chosen such that, in the use, a meltable polymer is used as first material, the modulus of elasticity at this temperature, determined by means of DMA, storage modulus as G′ (DMA, plate/plate oscillation viscometer to ISO 6721-10:2011-08 at a shear rate of l/s), of the meltable polymer is ≥10⁵ Pa to ≤10⁸ Pa, preferably ≥5·10⁵ Pa to ≤5·10⁷ Pa, more preferably ≥1·10⁶ Pa to ≤1·10⁷ Pa. This permits effective treatment of the article with minimization of the risk of deformation of the green body.

Further preferably, for effective treatment of the article, it may be the case that the contacting of the article obtained with the powder bed in method step b) is conducted for a period within a range from ≥1 minute to ≤174 hours. It may further preferably be the case that the contacting of the article obtained with the powder bed in method step b) is performed for a period within a range from ≥10 minutes to ≤48 hours, further preferably within a range from ≥15 minutes to ≤24 hours, further preferably within a range from ≥20 minutes to ≤8 hours.

For example, in the case of the above-described periods of time, especially in the case of a treatment time of ≥1 minute to ≤72 hours, for the treatment of the article in method step b), it may further be the case that the temperature T of the powder bed or of the liquid is preferably varied in the course of method step b) and the temperature curve may optionally include temperatures of −190° C. to +2000° C. This may enable a particularly adaptive treatment, where it is possible to react to or take account of changing properties of the article during the treatment.

In a further preferred embodiment, it is still the case when the first material includes a binder that the temperature T, expressed in degrees Celsius, is ≤95%, preferably ≤90%, more preferably ≤85%, of the breakdown temperature of the binder after crosslinking, where the breakdown temperature is defined as the temperature at which a loss of mass of ≥10% is established in a thermogravimetric analysis at a heating rate of 20° C./min in a nitrogen stream. In this configuration, it is again possible to enable effective and simultaneously gentle treatment of the article.

Specified hereinafter, in tables 1 and 2, are examples of combinations of first materials and materials for the powder bed or the liquid that are particularly preferable in accordance with the invention but not limiting in any way.

Examples of particularly suitable combinations of meltable polymers or thermoplastics for method step a) as first material and liquids as second material for method step b) in the method of the invention are listed hereinafter in table 1:

TABLE 1
Material examples for first and second material

| Meltable polymer (first material) | Liquid (second material) |
|---|---|
| Thermoplastic polyurethane (TPU) | Silicone oil, PE waxes, hydrofluorocarbons |
| Polycarbonate (PC) | Silicone oil, PE waxes |
| Polymethylmethacrylate (PMMA) | Saltwater, silicone oil, PE waxes |
| Polyamide (PA) | Silicone oil, hydrofluorocarbons |
| Polypropylene (PP) | Silicone oil, saltwater |
| Polystyrene (PS) | Silicone oil, saltwater |
| Acrylonitrile-butadiene-styrene (ABS) | Silicone oil, PE waxes, saltwater |
| Polyethylene (PE) | Silicone oil, saltwater |
| Polychloroprene rubber (CR) | Silicone oil, saltwater |
| Styrene-butadiene block copolymers (SBS) | Silicone oil, saltwater |
| Polyvinylchloride (PVC) | Silicone oil, saltwater |
| Polyvinylacetate (PVA) | Silicone oil, PE waxes |

Examples of particularly suitable combinations of meltable polymers or thermoplastics for method step a) as first material and of materials of a powder bed as second material for method step b) in the method of the invention are listed hereinafter in table 2:

TABLE 2
Material examples for first and second material

| Meltable polymer (first material) | Powder bed (second material) |
|---|---|
| Thermoplastic polyurethane (TPU) | NaCl, MgSO₄, MgCl₂, CaCO₃ |
| Polycarbonate (PC) | NaCl, MgSO₄, MgCl₂, CaCO₃ |
| Polymethylmethacrylate (PMMA) | NaCl, MgSO₄, MgCl₂, CaCO₃ |
| Polyamide (PA) | NaCl, MgSO₄, MgCl₂, CaCO₃ |
| Polypropylene (PE) | NaCl, MgSO₄, MgCl₂, CaCO₃, starch, sugar |
| Acrylonitrile-butadiene-styrene (ABS) | NaCl, MgSO₄, MgCl₂, CaCO₃, starch, sugar |
| Polyethylene (PE) | NaCl, MgSO₄, MgCl₂, CaCO₃, starch, sugar |
| Polychloroprene rubber (CR) | NaCl, MgSO₄, MgCl₂, CaCO₃, starch, sugar |
| Styrene-butadiene block copolymers (SBS) | NaCl, MgSO₄, MgCl₂, CaCO₃, starch, sugar |
| Polyvinylchloride (PVC) | NaCl, MgSO₄, MgCl₂, CaCO₃, starch, sugar |
| Polyvinylacetate (PVA) | NaCl, MgSO₄, MgCl₂, CaCO₃, starch, sugar |
| Polyfluoroethylene (PTFE) | NaCl, MgSO₄, MgCl₂, |
| Polyetheretherketone (PEEK) | NaCl, MgSO₄, MgCl₂, |
| Nylon-6 | NaCl, MgSO₄, MgCl₂, CaCO₃ |
| Nylon-6,6 | NaCl, MgSO₄, MgCl₂, CaCO₃ |
| Nylon-12 | NaCl, MgSO₄, MgCl₂, CaCO₃ |
| Nylon-4,6 | NaCl, MgSO₄, MgCl₂, CaCO₃ |
| Nylon-11 | NaCl, MgSO₄, MgCl₂, CaCO₃ |
| Copolyamide | NaCl, MgSO₄, MgCl₂, CaCO₃ |
| Copolyesteramide | NaCl, MgSO₄, MgCl₂, CaCO₃ |
| Copolyetheramides (PEBA) | NaCl, MgSO₄, MgCl₂, CaCO₃ |
| Polyaryletherketone (PEAK) | NaCl, MgSO₄, MgCl₂, CaCO₃ |
| Polyimides | NaCl, MgSO₄, MgCl₂, CaCO₃ |
| Polyarylsulfones | NaCl, MgSO₄, MgCl₂, CaCO₃ |

The present invention further provides a treated article obtainable by a method as described in detail above. Such an article may especially have improved mechanical properties. The article produced by the method of the invention has a surface having an average roughness Ra (DIN EN ISO 4287:2010-07) of ≤500 μm, preferably of ≤200 μm, or preferably of ≤100 μm, or preferably within a range from 10 to 500 μm, or preferably within a range from 50 to 100 μm.

Such an article is particularly notable for its particularly high stability, and at the same time also for particularly homogeneous mechanical properties by virtue of the article.

With regard to mechanical properties, particular mention should be made of density as a measure of high physical stability and of tensile strength, which is especially the stability of the article in the plane of the layer.

In this regard, it is particularly preferable that, in the tensile test in accordance with DIN EN ISO 527-2:2012, the product has a tensile strength greater than the tensile strength of the untreated article, or, in other words, that the layers of the treated article have a tensile strength with respect to one another after method step b) that is greater than before method step b). It is particularly preferable here that, in the tensile test in accordance with DIN EN ISO 527-2:2012, the layers of the treated article have a tensile strength with respect to one another that is greater than the tensile strength of the untreated article by a magnitude of ≥10%, preferably by a magnitude of ≥20%, further preferably by a magnitude of ≥30%, further preferably by a magnitude of ≥50%, further preferably by a magnitude of ≥100%, where the values described above relate to the tensile strength of the untreated article or of the article before method step b).

It may further be preferable for the density of the treated article to be greater than the density of the untreated article, or in other words for the density after method step b) to be greater than before method step b). It may be particularly preferable here for the density of the treated article to be greater than the density of the untreated article by a magnitude of ≥2%, preferably by a magnitude of ≥5%, further preferably by a magnitude of ≥8%, further preferably by a magnitude of ≥10%, based on the density of the untreated article or based on the density of the article before method step b).

These mechanical properties in particular can be improved by the method described here by comparison with conventional additively manufactured articles.

For further advantages and technical features of the method, reference is made to the description of the article that follows, and vice versa.

### EXAMPLES

Detailed hereinafter are various experiments in which an article created by an FDM or SLS method or DLP method as additive manufacturing method in method step a) and treated by method step b) is examined for its properties before and after method step b).

### Test Methods:

Shore A: In accordance with DIN ISO 7619-1:2012-02, the test specimen thickness required was attained by multiple stacking of the test specimens obtained.

Tensile test: In accordance with DIN EN ISO 527-2:2012, the test specimens were not stored under standard climatic conditions for 24 hours before the measurement.

IR (ATR): Evaluation of the ratio of the maximum height of the isocyanate band in the wavenumber range from 2170 to 2380 to the maximum height of the CH stretch vibration in the wavenumber range from 2600 to 3200.

### Equipment:

FDM printer: For the experiments, a Massportal Pharaoh XD 20 FDM/FFF 3D printer was used. This features a very substantially closed build space and a Bowden extruder.

SLS printer: For the experiments, a Farsoon FS251P 3D printer was used.

DLP printer: For the experiments, an Autodesk Ember 3D printer was used.

### Starting Materials:

Silicone oil (silicone oil bath): Silotherm200 Infrasolv from LABC Labortechnik Zillger KG, colorless

Silicone oil (heat carrier oil) was sourced via specialist laboratory suppliers and used as sourced.

NaCl: edible salt with grain size from 0.1 to 0.9 mm.

Sand (filter sand): quartz sand with grain size from 0.4 to 0.8 mm.

### Resin A:

25 g of the reaction product of the 1,6-HDI trimer with hydroxyethyl acrylate and the following idealized structure:

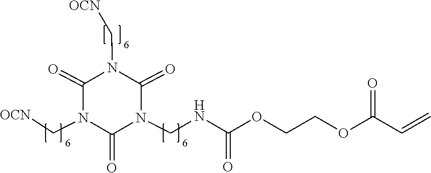

50 g of the polyurethane acrylate Ebecryl 4101 (sourced from Allnex SA)
25 g of butyl acrylate (sourced from Sigma Aldrich)
3 g of the photoinitiator Omnirad 1173 (sourced from IGM Resins)
(alternatively when the Autodesk Ember 3D printer was used, 1.5 g of the photoinitiator Omnirad BL 750 from IGM Resins and 0.13 g of 2,5-bis(5-tert-butylbenzoxazol-2-yl)thiophene were used as free-radical scavenger in place of Omnirad 1137).
0.5 g of a catalyst complex consisting of: 55.6% by weight of Desmodur® N 3600 (Covestro Deutschland AG) and 44.4% by weight of Jeffcat® Z 110 (sourced from Huntsman Co). These resin A starting materials were combined in a Thinky ARE250 planetary mixer and mixed at a speed of 2000 revolutions per minute at room temperature for about 2 minutes.

Experiment 17: The free-radically curable resin A was drawn down onto a glass plate in 3 layers one on top of another with coating bars of different dimensions, hence simulating a 3D printing method in the manner of a DLP 3D printer. The glass plate had previously been treated with a 1% solution of soy lecithin in ethyl acetate and dried. The soy lecithin acted as a release agent to allow the cured films to be detached from the substrate again later. The dimensions were 400 μm, 300 μm and 200 μm. The respective layers applied were each cured in a Superfici UV curing unit with mercury and gallium radiation sources at a belt speed of 5 m/min. The lamp output and belt speed resulted in a radiation intensity of 1300 mJ/cm² acting on the coated substrates. This resulted in a three-layer structure of around 900 μm in total. The cured films were carefully removed from the glass substrates in order to give test specimens for mechanical and IR spectroscopy characterization.

All infrared spectra were measured on a Bruker FT-IR spectrometer equipped with an ATR unit, unless stated otherwise.

For the relative measurement of the change in the free NCO groups on films, a Bruker FT-IR spectrometer (Tensor II) was used. The sample was contacted with the platinum ATR unit. The contact area of the sample was 2×2 mm. In the course of measurement, the IR radiation penetrated 3-4 μm into the sample according to wavenumber. An absorption spectrum was then obtained from the sample. In order to compensate for nonuniform contacting of the samples of different hardness, a baseline correction and a normalization in the wavenumber range of 2600-3200 (CH2, CH3) was performed on all spectra. The peak height of the “free” NCO group was determined in the wavenumber range of 2170-2380, and the ratio of the NCO signals to the highest peak was ascertained in the range of 2900-3200 (CH).

For the measurement of Shore A hardness to DIN ISO 7619-1:2012-02, individual layers of the film were combined to form a test specimen of height at least 6 mm and the hardness value was determined.

Experiment 18: The free-radically curable resin A was drawn down onto a glass plate as described in experiment 17, UV-cured and removed from the glass substrate. Subsequently, the self-supporting film was introduced vertically into a salt bed, such that it was completely surrounded by salt. Subsequently, it was stored under standard atmosphere in an oven at 185° C. for 1 hour. IR spectroscopy and hardness measurements were conducted on this post-cured film, as described in experiment 17.

Experiment 19*: The free-radically curable resin A was drawn down onto a glass plate as described in experiment 17, UV-cured and removed from the glass substrate. Subsequently, the self-supporting film was introduced into the oven vertically in a free-standing manner. Subsequently, it was stored under standard atmosphere in an oven at 185° C. for 1 hour. The film curved during the curing process to give a U, which was dimensionally stable after curing. IR spectroscopy and hardness measurements were conducted on this post-cured film, as described in experiment 17.

TPUs used in accordance with the invention were produced by two standard processing methods: the prepolymer method and the one-shot/static mixer method.

In the prepolymer method, the polyol or polyol mixture is preheated to 180 to 210° C., initially charged with a portion of the isocyanate, and converted at temperatures of 200 to 240° C. The speed of the twin-screw extruder used here is about 270 to 290 rpm. This preceding partial reaction affords a linear, slightly pre-extended prepolymer that reacts to completion with residual isocyanate and chain extender further down the extruder. This method is described by way of example in EP-A 747 409.

In the one-shot/static mixer method, all comonomers are homogenized by means of a static mixer or another suitable mixing device at high temperatures (above 250° C.) within a short time (below 20 s) and then reacted to completion and discharged by means of a twin-screw extruder at temperatures of 90 to 180° C. and a speed of 260-280 rpm. This method is described by way of example in application DE 19924089.

### TPU A 1.75 mm Filament

The TPU (thermoplastic polyurethane) was prepared by the prepolymer method from 1 mol of polyether polyol (DuPont) having a number-average molecular weight of 1000 g/mol, based on polytetramethylene ether glycol, and 5.99 mol of butane-1,4-diol; 6.99 mol of technical grade diphenylmethane 4,4′-diisocyanate (MDI) with >98% by weight of 4,4′-MDI; 0.25% by weight of Irganox® 1010 (pentaerythritol tetrakis (3-(3,5-di-tert-butyl-4-hydroxyphenyl)propionate) from BASF SE) and 0.3% by weight of Loxamid 3324.

The filaments were extruded from the granular material by the standard method, cooled down in a water bath, dried in a hot air zone and taken up using a winder. Before use in the 3D printer, the filaments were dried at 40° C. for 48 h.

TPU powder blend composed of the raw materials TPU 1/TPU 2: The powder blend was produced from the powders of TPU 1 and TPU 2 by weighing out the respective components. The two materials were mixed in a commercial TM5 Thermomix at setting 10 for 2*5 s.

### Raw Material TPU 1

TPU (thermoplastic polyurethane) 1 was prepared from 1 mol of polyester diol (Covestro) having a number-average molecular weight of about 900 g/mol, based on about 56.7% by weight of adipic acid and about 43.3% by weight of butane-1,4-diol, and about 1.41 mol of butane-1,4-diol, about 0.21 mol of hexane-1,6-diol, about 1.62 mol of technical grade diphenylmethane 4,4′-diisocyanate (MDI) with >98% by weight of 4,4′-MDI, 0.05% by weight of Irganox® 1010 (pentaerythritol tetrakis(3-(3,5-di-tert-butyl-4-hydroxyphenyl)propionate) from BASF SE), 1.1% by weight of Licowax® E (montanic esters from Clariant) and 250 ppm of tin dioctoate.

### Raw Material TPU 2

TPU (thermoplastic polyurethane) 2 was prepared from 1 mol of polyester diol (Covestro) having a number-average molecular weight of about 900 g/mol, based on about 56.7% by weight of adipic acid and about 43.3% by weight of butane-1,4-diol, and about 2.38 mol of butane-1,4-diol, about 0.22 mol of hexane-1,6-diol, about 2.6 mol of technical grade diphenylmethane 4,4′-diisocyanate (MDI) with >98% by weight of 4,4′-MDI, 0.05% by weight of Irganox® 1010 (pentaerythritol tetrakis(3-(3,5-di-tert-butyl-4-hydroxyphenyl)propionate) from BASF SE), 1.1% by weight of Licowax® E (montanic esters from Clariant) and 250 ppm of tin dioctoate.

0.2% by weight, based on TPU, of hydrophobized fumed silica was added as flow agent (Aerosil® R972 from Evonik) to the TPUs prepared under Raw material TPU 1 and Raw material TPU 2, and the mixture was processed mechanically under cryogenic conditions (cryogenic comminution) in a pinned-disk mill to give powder and then classified by means of a sieving machine. 90% by weight of the composition had a particle diameter of less than 140 μm (measured by means of laser diffraction (HELOS particle size analysis)).

1.75 mm filament PC1 based on Makrolon® XT5010, MVR (300° C./1.2 kg) 34 cm³/10 min: The filaments were extruded from the granular material by the standard method, cooled with air and taken up using a winder.

In step 1, by the FDM printing method (for conditions see table 3), the TPU A filaments and PC1 S2 were used to produce tensile specimens in the form according to ISO 527-2 2012.

Also produced in step 1 by the SLS printing method (for conditions see table 3), from the powder mixtures of raw material TPU 1 and raw material TPU 2 S2, were tensile specimens according to ISO 527-2 2012.

Also produced in step 1 by the DLP printing method (for conditions see table 3) were S2 tensile specimens in the form according to ISO 527-2 2012.

In step 2, the tensile specimens obtained were subjected to thermal post-curing. Comparative experiments are identified by *; there is variation in the post-curing conditions, see table 4. Subsequent heat treatment was effected in an air circulation drying cabinet at the defined temperature, with horizontal positioning of the test specimens to be tested in the medium in a 250 ml aluminum dish, fully covered by the medium, and with heating of the drying cabinet from RT to the target temperature within 30 min. After attainment of the target temperature, the test specimen was heated at target temperature for the desired time. Thereafter, the aluminum dish was taken out of the drying cabinet while hot and cooled down to room temperature RT on a laboratory bench. After attainment of RT but no later than after 30 min, the samples were removed, dried and freed of the medium, for example by rinsing with water.

After the thermal post-curing, the tensile specimens obtained were analyzed further for mechanical and chemical composition; see table 5. Results of the comparative experiments are again identified by an *.

TABLE 3
Materials and methods conditions

| | | TPU blend |
|---|---|---|
| | TPU blend | TPU 1/TPU 2 |
| Material/SLS | TPU 1/TPU 2 (50/50) | (70/30) |
| Build space temperature ° C. | 80 | 80 |
| Laser power [W] | 48 | 48 |
| Layer thickness [mm] | 0.12 | 0.12 |
| Number of exposures per layer | 2 | 2 |
| (fill scan count) | | |
| Overlap of laser traces | 0.15 | 0.15 |
| (slicer fill scan spacing) [mm] | | |
| Roller speed [mm/s] | 180 | 180 |
| Material/FDM | TPU A | PC1 |
| Extruder temperature [° C.] | 245 | 285 |
| Build platform temperature [° C.] | 60 | 100 |
| Extrusion speed [mm/s] | 40 | 40 |
| Layer height [mm] | 0.2 | 0.2 |
| Nozzle size [mm] | 0.4 | 0.4 |
| Material/DLP | Resin A | |
| Build space temperature [° C.] | 23 | |
| Layer height [mm] | 0.05 | |
| Exposure/layer [s] | 1.7 | |

In the FDM method, printing was effected without external layers (top solid layer/bottom solid layer). 2 outer tracks (perimeter) and an infill of 45° were used. All samples were printed in Z direction, i.e. vertically on the build platform.

The properties of the articles created after method step 1 are described in detail as comparative experiments in table 5 below.

TABLE 4
Post-sintering conditions

| Experiment | Temperature | Time | Cooling time | Medium |
|---|---|---|---|---|
| (First material) | [° C.] | [min] | to RT [min] | (second material) |
| TPU A | | | | |
| 1* | 23 | — | — | — |
| 2 | 180 | 60 | 30 | Salt |
| 3 | 190 | 60 | 30 | Salt |
| 4 | 200 | 60 | 30 | Salt |
| 5 | 210 | 60 | 30 | Salt |
| PC1 | | | | |
| 6* | 23 | — | — | — |
| 7 | 190 | 60 | 30 | Salt |
| 8 | 180 | 60 | 30 | Salt |
| TPU blend TPU | | | | |
| 1/TPU 2 (50/50) | | | | |
| 9* | 23 | — | — | — |
| 10 | 200 | 60 | 30 | Silicone oil |
| 11 | 200 | 60 | 30 | Salt |
| 12 | 200 | 60 | 30 | Sand |
| TPU blend TPU | | | | |
| 1/TPU 2 (70/50) | | | | |
| 13* | 23 | — | — | — |
| 14 | 200 | 60 | 30 | Silicone oil |
| 15 | 200 | 60 | 30 | Salt |
| 16 | 200 | 60 | 30 | Sand |
| Resin A | | | | |
| 17* | 23 | — | — | — |
| 18 | 185 | 60 | 30 | Salt |

Marked * means comparative experiment

TABLE 5
Properties after treatment

| | | | Maximum | |
|---|---|---|---|---|
| | | | Elongation at | |
| | Shore A | Tensile strength | break | ISO/CH band |
| Experiment | hardness | [N/mm²] | [%] | ratio in IR |
| TPU A | | | | |
| 1* | | 2.8 | 1.4 | |
| 2 | | 8.8 | 8.6 | |
| 3 | | 8.6 | 12.7 | |
| 4 | | 9 | 9.1 | |
| 5 | | 11 | 6.2 | |
| PC1 | | | | |
| 6* | | 25 | 3 | |
| 7 | | 41 | 3.6 | |
| 8 | | 37 | 2.7 | |
| TPU blend TPU | | | | |
| 1/TPU 2 (50/50) | | | | |
| 9* | | 3.75 | 133.0 | |
| 10 | | 6.03 | 209.7 | |
| 11 | | 16.0 | 400.5 | |
| 12 | | 8.57 | 385.0 | |
| TPU blend TPU | | | | |
| 1/TPU 2(70/30) | | | | |
| 13* | | 3.48 | 118.0 | |
| 14 | | 5.56 | 168.9 | |
| 15 | | 17.2 | 386.6 | |
| 16 | | 11.2 | 441.2 | |
| Resin A 17* | 70 | | | 1:1 |
| 18 | 90 | | | 1:10 |
| 19* | 90 | | | 1:10 |

Marked * means comparative experiment

The comparison of the results for the method of the invention shows a distinct improvement in mechanical properties after thermal treatment according to the invention compared to non-heat-treated specimens. Moreover, heated storage in media having higher density than air achieved a distinct improvement in dimensional stability of the test specimens since these are less actively subjected to gravity. This is especially manifested when complex components having unsupported geometries as clearly apparent in the comparative example of experiment 19 are thermally post-cured. The unsupported geometries were deformed by gravity during the curing process and cure in this deformed shape.

1. A method of producing a treated article, comprising:
a) creating an article by additive manufacturing, wherein
the article is created by arranging at least one first material on a substrate repeatedly in layers and in a spatially selective manner corresponding to a cross section of the article; and
b) at least partly contacting the article created by additive manufacturing with a second material heated to ≥T for a period of ≥1 min in order to obtain the treated article, wherein the second material is a heated liquid or a heated powder bed, and
wherein
T is a temperature of ≥25° C.

2. The method as claimed in claim 1, further comprising one or more of the following:
A) detaching the article created by additive manufacturing from the substrate before method step b);
B) at least partly removing unreacted first material from the additively manufactured article before method step b);
C) post-curing the article created by additive manufacturing in method step a) by means of actinic radiation;
D) cooling the heated liquid or the heated powder bed to a temperature in a region of <200° C. before removal of the treated article after method step b);
E) at least partly mechanically removing the second material from the article during or after method step b); or
F) washing off the second material after method step b) with a solvent for a period of ≤30 min after removal of the article from the liquid or the powder, where the solvent is not a solvent or co-reactant for the first material at a temperature in a region of T ≤200° C.

3. The method as claimed in claim 1, wherein the additive manufacturing method is selected from the group consisting of high-speed sintering, selective laser melting, selective laser sintering, selective heat sintering, binder jetting, electron beam melting, fused deposition modeling, fused filament fabrication, build-up welding, friction stir welding, wax deposition modeling, contour crafting, metal powder application methods, cold gas spraying, stereolithography, 3D screen printing methods, light-scattered electrophoretic deposition, printing of highly metal powder-filled thermoplastics by a fused deposition modeling method, nanoscale metal powder by an inkjet method, direct light processing, ink-jetting, and continuous light interface processing.

4. The method as claimed in claim 1, wherein, during the contacting of the article with the liquid or the powder bed in method step b), the liquid or the powder bed is put at least intermittently under a pressure within a range from ≥1 bar to ≤1000 bar.

5. The method as claimed in claim 1, wherein, during the contacting of the article with the liquid or the powder bed in method step b), the liquid or the powder bed is put at least intermittently under a pressure within a range from ≥0.01 bar to ≤1 bar.

6. The method as claimed in claim 1, wherein, during the contacting of the article with the liquid or the powder bed in method step b), the second material in the form of the powder bed or of the liquid is flooded at least intermittently with an inert gas.

7. The method as claimed in claim 1, wherein the second material is water-soluble.

8. The method as claimed in claim 1, wherein the second material is soluble in an acid, a base, or an organic solvent.

9. The method as claimed in claim 1, wherein the second material is a powder bed consisting of comprising silicon dioxide, polytetrafluoroethylene, aluminum oxide, metals, a metal salts, a sugars, an organic salts, polyethylene wax, polyester, polyacrylic acid, polyethylene oxide, polyoxymethylene, polycarbonate, or mixtures thereof.

10. The method as claimed in claim 1, wherein the temperature T is on average ≤95% of a breakdown temperature of the first material.

11. The method as claimed in claim 1, wherein the temperature T is within a range from ≥40° C. to ≤2000° C.

12. The method as claimed in claim 1, wherein the temperature T is greater than a temperature 50° C. below a Vicat softening temperature of the first material, and the temperature T is less than a temperature 150° C. above the Vicat softening temperature of the first material, where the Vicat softening temperature can be ascertained according to DIN EN ISO 306:2014-03.

13. The method as claimed in claim 1, wherein the contacting of the article obtained with the powder bed in method step b) is conducted for a period within a range from ≥1 minute to ≤174 hours.

14. The method as claimed in claim 1, wherein the temperature T of the powder bed or of the liquid is altered in the course of method step b).

15. A treated article obtained by the method as claimed in claim 1.

16. The article as claimed in claim 15, wherein the treated article in a tensile test in accordance with DIN EN ISO 527-2:2012 has a tensile strength greater than a tensile strength of an untreated article before step b).

17. The article as claimed in claim 15, wherein a density of the treated article is greater than a density of an untreated article before step b).

18. The method as claimed in claim 1, wherein the second material is a liquid comprising a silicone oil, a paraffin oil, a fluorinated hydrocarbon, a polyethylene wax, saltwater, a metal melt, an ionic liquid, or a mixture thereof.

19. The method as claimed in claim 14, wherein the temperature curve comprises a temperature from −190° C. to +2000° C., and wherein the contacting of the article obtained with the powder bed in method step b) is performed for a period of ≥1 minute to ≤72 hours.
